(19) United States
(12) Patent Application Publication
(10) Pub. No.: US 2025/0012942 A1
(43) Pub. Date: Jan. 9, 2025

(54) Constrained Simultaneous Source Shooting

(71) Applicant: BP Corporation North America Inc., Houston, TX (US)

(72) Inventors: John Theodore ETGEN, Houston, TX (US); Kang FU, Katy, TX (US)

(73) Assignee: BP Corporation North America Inc., Houston, TX (US)

(21) Appl. No.: 18/760,686

(22) Filed: Jul. 1, 2024

Related U.S. Application Data
(60) Provisional application No. 63/511,996, filed on Jul. 5, 2023.

(51) Int. Cl. G01V 1/38

(52) U.S. Cl. CPC G01V 1/3843

(57) ABSTRACT

System and techniques to fire a first source array at a first time of a first shot timing distribution comprising first time values according to a firing schedule and fire a second source array at a second time of a second shot timing distribution comprising second time values subsequent to firing the first source array and prior to another firing of the first source array according to the firing schedule. Additionally, at least a portion of the second shot timing distribution overlaps with the first shot timing distribution or the at least a portion of the second shot timing distribution is separated from the first shot timing distribution by less than a predetermined period of time and the first time and the second time of the firing schedule are separated by at least the predetermined period of time.

### CROSS-REFERENCE TO RELATED APPLICATIONS

This application claims priority to U.S. Provisional Patent Application No. 63/511,996 filed on Jul. 5, 2023 and titled “Constrained Simultaneous Source Shooting,” which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to seismic data acquisition, and more specifically, to simultaneous source shooting techniques to increase the separability of overlapping shots.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A seismic survey includes generating an image or map of a subsurface region of the Earth by sending acoustic energy down into the ground and recording the reflected acoustic energy that returns from the geological layers within the subsurface region. During a seismic survey, an energy source is placed at various locations on or above the surface region of the Earth, which may include hydrocarbon deposits. Each time the source is activated, the source generates a seismic (e.g., acoustic wave) signal that travels downward through the Earth, is reflected, and, upon its return, is recorded using one or more receivers disposed on or above the subsurface region of the Earth. The seismic data recorded by the receivers may be used to create an image or profile of the corresponding subsurface region.

Seismic data acquisition can be a time consuming and expensive process. One technique to reduce the time and cost required to acquire seismic data is the use of two or more sources that are fired close in time to one another (i.e., multiple sources are sequentially activated during a single recording period). However, while this technique may decrease the amount of time and cost associated with seismic acquisition, the resultant seismic data may include noise. One example of this noise is blending noise, which refers to signals received during data collection periods that interfere with a current data collection period and may be read as noise (e.g., weak-coherence energy or signal) despite being part of a primary signal (e.g., coherent energy or signal) for a subsequent input data (e.g., input seismic data) collection period corresponding to another source activation. It may be desired to develop and/or improve techniques associated with seismic acquisition that increase the incoherency of the resultant noise generated from the firing of two or more sources during a data collection period such that the resultant noise may be separated effectively by data processing.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Seismic acquisition utilizing sources and receivers may be useful in the generation of, for example, seismic images. Seismic images may be used, for example, in the determination of hydrocarbon deposits (e.g., areas within a subsurface that contain hydrocarbons) and/or subsurface drilling hazards. Seismic images are generally produced using seismic waveforms produced by a source, reflected off regions within a subsurface, and received by one or more receivers. However, noise associated with the seismic acquisition can render portions of the gathered data unusable.

Accordingly, present techniques include towing multiple source arrays to increase data density and/or reduce operation run time and cost. Additionally, present techniques allow for the increase of the number of sampling of source positions. Additionally, present techniques address some of the limits to increasing the number of sampling of source positions in a seismic survey that would otherwise be capped, for example, due to interference between samples. One technique to alleviate and/or eliminate overlap in reflected wave reception with subsequent shot firing times includes adjusting the timing of shot timings to include adjusted (e.g., dithered) by, for example, a random amount of time. Moreover, the present techniques include determination of the adjusted shot timings so that they do not conflict with one another. In this manner, sequential shots that have been adjusted will have their adjustments meet threshold requirements to preclude interference therebetween.

### BRIEF DESCRIPTION OF THE DRAWINGS

Various aspects of this disclosure may be better understood upon reading the following detailed description and upon reference to the drawings in which:

FIG. 1 illustrates a flow chart of various processes that may be performed based on analysis of seismic data acquired via a seismic survey system, in accordance with embodiments presented herein;

FIG. 2 illustrates a marine survey system in a marine environment, in accordance with embodiments presented herein;

FIG. 3 illustrates a second marine survey system in a marine environment, in accordance with embodiments presented herein;

FIG. 4 illustrates a computing system that may perform operations described herein based on data acquired via the marine survey systems of FIG. 2 and/or the survey system of FIG. 3, in accordance with embodiments presented herein;

FIG. 5 illustrates a first technique of seismic acquisition in a marine environment utilizing the marine survey system of FIG. 2 or the second marine survey system of FIG. 3, in accordance with embodiments presented herein;

FIG. 6 illustrates a second technique of seismic acquisition in a marine environment utilizing the marine survey system of FIG. 2 or the second marine survey system of FIG. 3, in accordance with embodiments presented herein;

FIG. 7 illustrates a third technique of seismic acquisition in a marine environment utilizing the marine survey system of FIG. 2 or the second marine survey system of FIG. 3, in accordance with embodiments presented herein;

FIG. 8 illustrates a timing diagram that represents times at which a series of shots may be taken in conjunction with the seismic acquisition of FIG. 6 or FIG. 7, in accordance with embodiments presented herein;

FIG. 9 illustrates a shot diagram that includes a first embodiment of shot timing distributions, in accordance with embodiments presented herein;

FIG. 10 illustrates a second shot diagram that includes a second embodiment of shot timing distributions, in accordance with embodiments presented herein;

FIG. 11 illustrates a third shot diagram that includes a third embodiment of shot timing distributions, in accordance with embodiments presented herein;

FIG. 12 illustrates a method to eliminate conflicts in firings with respect to the second shot diagram of FIG. 10, in accordance with embodiments presented herein; and

FIG. 13 illustrates a second method to eliminate conflicts in firings with respect to the second shot diagram of FIG. 10, in accordance with embodiments presented herein.

### DETAILED DESCRIPTION OF SPECIFIC EMBODIMENTS

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Analysis of seismic data may provide valuable information, such as the location and/or change of hydrocarbon deposits within a subsurface region of the Earth. The present disclosure generally discusses techniques that may be used to obtain seismic data via increases in the amount of sampling of source positions in a seismic survey. Improvements to the acquisition design allow for increases of the data density and provide additional advantages of increase efficiency.

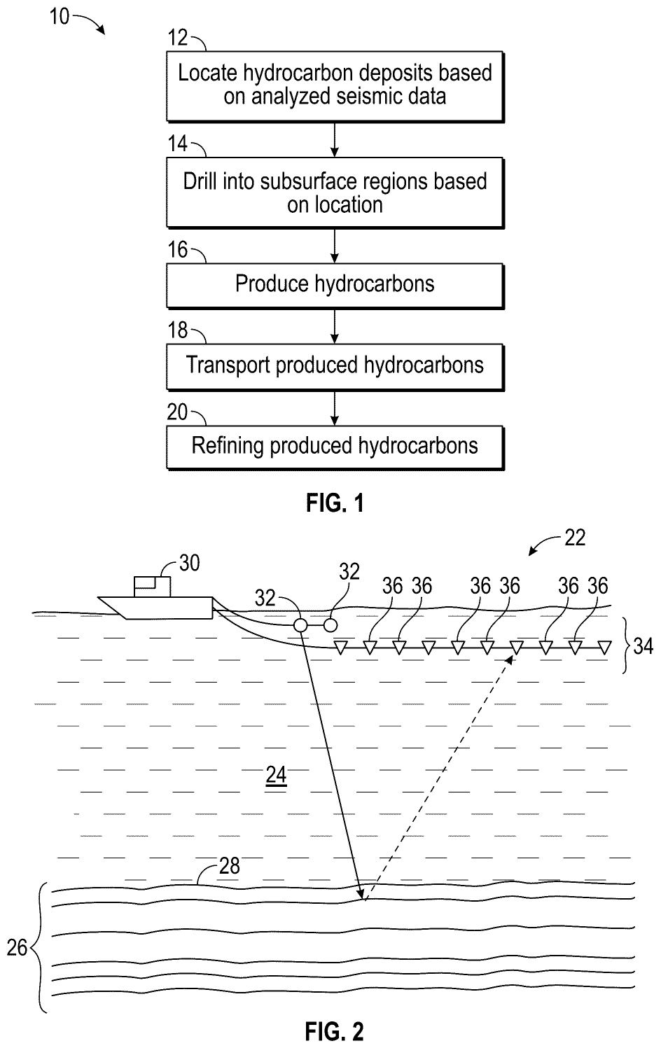

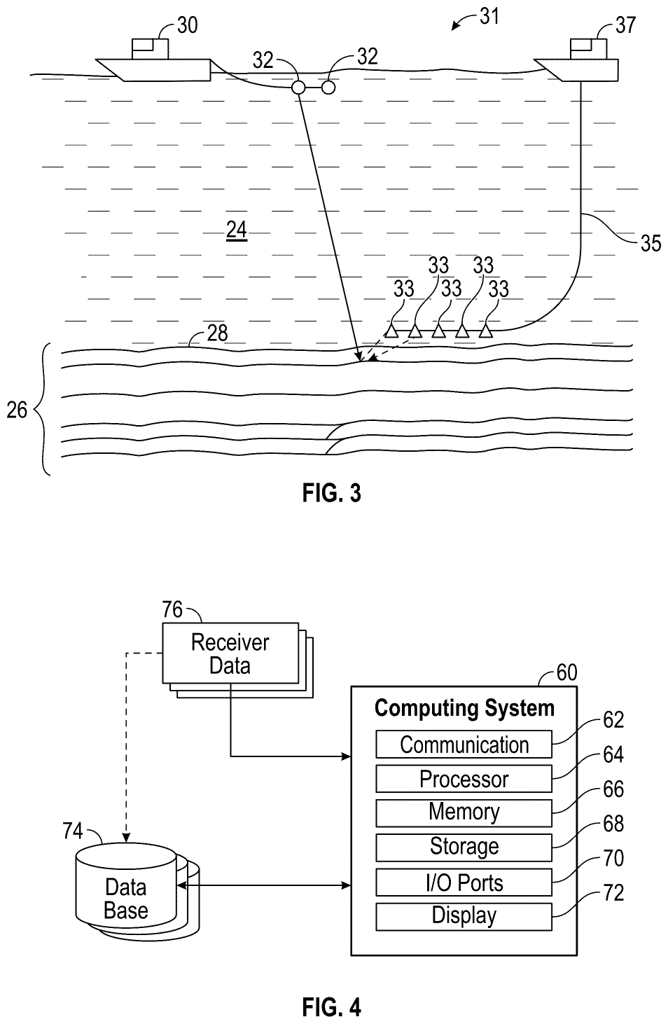

By way of introduction, seismic data may be acquired by using a variety of seismic survey systems and techniques, examples of which are discussed with respect to FIG. 2 and FIG. 3. Regardless of the gathering technique utilized, after the seismic data is acquired, a computing system may analyze the acquired seismic data and use results of the seismic data analysis (e.g., seismogram, map of geological formations, or the like) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it is noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired via one or more seismic acquisition techniques may be analyzed to generate a map or profile that illustrates various geological formations within the subsurface region.

Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries, storage facilities, processing sites, and the like, via transport vehicles, pipelines, and the like. At block 20, the produced hydrocarbons may be processed according to various refining procedures to develop different products using the hydrocarbons.

It is noted that the processes discussed with regard to the method 10 may include other suitable processes that may be based on the locations and properties of hydrocarbon deposits as indicated in the seismic data acquired via one or more seismic survey. As such, it may be understood that the processes described above are not intended to depict an exhaustive list of processes that may be performed after determining the locations and properties of hydrocarbon deposits within the subsurface region.

With the forgoing in mind, FIG. 2 illustrates a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a streamer 34 (e.g., a seismic streamer), one or more receivers 36 (e.g., seismic receivers), and/or other equipment that may assist in acquiring seismic images representative of geological formations within a subsurface region 26 of the Earth. The vessel 30 may tow the one or more seismic sources 32 (e.g., an airgun array, another array of energy sources, a single energy source, or a combination thereof) that may produce energy, such as acoustic waves (e.g., seismic waveforms), that is directed at a seafloor 28. The vessel 30 may also tow the streamer 34 having the one or more receivers 36 (e.g., one or more hydrophones) that may acquire seismic waveforms that represent the energy output by the seismic sources 32 subsequent to being reflected off of various geological formations (e.g., salt domes, faults, folds, etc.) within the subsurface region 26. Additionally, although the marine survey system 22 is described with one or more seismic sources 32 (represented in FIG. 2 as an airgun array) and one or more receivers 36 (represented in FIG. 2 as a plurality of hydrophones), it is noted that the marine survey system 22 may include multiple seismic sources 32 and multiple receivers 36. In the same manner, although the above descriptions of the marine survey system 22 is described with one streamer 34, it is noted that the marine survey system 22 may include multiple streamers 34. In addition, additional vessels 30 may include additional seismic sources 32, streamers 34, and the like to perform the operations of the marine survey system 22.

FIG. 3 illustrates an Ocean Bottom Seismic (OBS) system as a second marine survey system 31 (e.g., for use in conjunction with block 12 of FIG. 1) that also may be employed to acquire seismic data (e.g., waveforms) regarding a subsurface region of the Earth in a marine environment. The OBS system may operate to generate seismic data (e.g., OBS datasets). While the illustrated OBS system is an Ocean Bottom Cable (OBC) system inclusive of one or more receivers 33 (e.g., seismic receivers) disposed on the seafloor 28 coupled via a cable 35 to a second vessel 37, other embodiments of an OBS system, such as an Ocean Bottom Node (OBN) system or any other seismic system that produces higher signal-to-noise images at differing frequencies compared to those of the marine survey system 22 may be utilized.

As illustrated, the OBS system may include one or more seismic sources 32 (e.g., an airgun array, another array of energy sources, a single energy source, or a combination thereof) that is towed by a vessel 30 and which may produce energy, such as sound waves (e.g., seismic waveforms), that is directed at the seafloor 28. This energy may be reflected off of various geological formations within the subsurface region 26 and subsequently acquired (e.g., received and/or recorded) by the one or more receivers 33 disposed on the seafloor 28. For example, data may be stored in the one or more receivers 33 for an extended period of time (e.g., hours, days, weeks, or longer) prior to the stored data being retrieved either via cable 35 or after the receivers are picked up through the cable 35 or via a Remotely Operated Vehicle (ROV). As illustrated, the one or more receivers 33 may be coupled to a vessel 37 (and, in some embodiments, to one another) via the cable 35. Data acquired via the one or more receivers 33 may be transmitted via the cable 35 to the vessel 37 (or, for example, wirelessly after the receivers 33 return to the vessel 37 if the OBS system is an OBN system). Although the marine survey system 31 is described with one or more seismic sources 32 (represented in FIG. 3 as an airgun array), it is noted that the marine survey system 31 may include multiple seismic sources 32.

In some embodiments, the OBS system may be utilized to acquire OBS datasets that are useful in reservoir mapping and characterization. These OBS datasets typically have a bandwidth from approximately 2 Hz to 100 Hz with relatively high signal-to-noise ratio (SNR) results at low frequencies (e.g., at less than or equal to approximately 50 Hz, 40 Hz, 35 Hz, etc.) relative to 3DHR datasets. Therefore, the OBS dataset is complementary with respect to bandwidth a 3DHR dataset acquired via the marine survey system 22 (e.g., acquired via a 2D high-resolution seismic acquisition, a 3D high-resolution seismic acquisition, or the like).

Although the methods and systems described herein are primarily directed to marine applications, they also may be applicable in land seismic operations. Regardless of how the seismic data is acquired, a computing system (e.g., for use in conjunction with block 12 of FIG. 1) may analyze the seismic waveforms acquired by the receiver 33 and/or receiver 36 to determine information regarding the geological structure, the location and property of hydrocarbon deposits, and the like within the subsurface region 26. FIG. 4 illustrates an example of such a computing system 60 that may perform various data analysis operations to analyze the seismic data acquired by the receivers 33, 36 to determine the structure of the geological formations within the subsurface region 26.

Referring now to FIG. 4, the computing system 60 may include a communication component 62, a processor 64, memory 66 (e.g., a tangible, non-transitory, machine readable media), storage 68 (e.g., a tangible, non-transitory, machine readable media), input/output (I/O) ports 70, a display 72, and the like. The communication component 62 may be a wireless or wired communication component that may facilitate communication between the receivers 33, 36, one or more databases 74, other computing devices, and other communication capable devices. In one embodiment, the computing system 60 may receive receiver data 76 (e.g., seismic data, seismograms) previously acquired by seismic receivers via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code or instructions to implement the methods described herein. The processor 64 may also include multiple processors that may perform the operations described below. The memory 66 and the storage 68 may be any suitable article of manufacture serving as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

The memory 66 and the storage 68 may also store the data, analysis of the data, the software applications, and the like. The memory 66 and the storage 68 may represent tangible, non-transitory, computer-readable media (e.g., any suitable form of memory or storage) that may store the processor-executable code used by the processor 64 to perform various techniques described herein. It may be noted that tangible and non-transitory merely indicates that the media is tangible and is not a signal.

The I/O ports 70 are interfaces that may couple to other peripheral components such as input devices (e.g., keyboard, mouse), sensors, input/output (I/O) modules, and the like. The I/O ports 70 may enable the computing system 60 to communicate with the other devices in the marine survey system 22 or the marine survey system 31.

The display 72 may depict visualizations associated with software or executable code processed via the processor 64. In one embodiment, the display 72 may be a touch display capable of receiving inputs from a user of the computing system 60. The display 72 may also be used to view and analyze results of any analysis of the acquired seismic data to determine geological formations within the subsurface region 26, the location and/or properties of hydrocarbon deposits within the subsurface region 26, and/or the like. The display 72 may be any suitable type of display, such as a liquid crystal display (LCD), plasma display, or an organic light emitting diode (OLED) display. In addition to depicting the visualization described herein via the display 72, it may be noted that the computing system 60 may also depict the visualization via other tangible elements, such as paper (e.g., via printing), or the like.

With the foregoing in mind, the present techniques described herein may also be performed using a supercomputer employing multiple computing systems 60, a cloud-computing system, or the like to distribute processes to be performed across multiple computing systems. In this case, each computing system 60 operating as part of a super computer may not include each component listed as part of the computing system 60. For example, each computing system 60 may not include the display 72 since the display 72 may not be useful for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, or the like regarding the subsurface region 26.

Although the components described above have been discussed with regard to the computing system 60, it may be noted that similar components may make up the computing system 60. Moreover, the computing system 60 may also be part of the marine survey system 22 or the marine survey system 31, and thus may monitor and/or control certain operations of the seismic sources 32 or 40, the receivers 33, 36, or the like. Further, it may be noted that the listed components are provided as example components, and the embodiments described herein are not to be limited to the components described with reference to FIG. 4.

In some embodiments, the computing system 60 (e.g., the processor 64 operating in conjunction with at least one of the memory 66 or the storage 68) may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that may extend for some distance. In a two-dimensional (2-D) seismic survey, the receiver locations may be placed along a single line, whereas, in a three-dimensional (3-D) survey, the receiver locations may be distributed across the surface in a grid pattern. As such, a 2-D seismic survey may provide a cross sectional picture (vertical slice) of Earth layers present directly beneath the recording locations. A 3-D seismic survey, on the other hand, may create a data “cube” or volume that may correspond to a 3-D picture of the subsurface region 26.

In addition, a four-dimensional (4-D) or time-lapse seismic survey may include seismic data acquired during a 3-D survey at multiple times. Using the different seismic images acquired at different times, the computing system 60 may compare the two images to identify changes in the subsurface region 26.

In any case, a seismic survey may include a large number of individual seismic recordings (e.g., seismic traces, traces). As such, the computing system 60 may analyze the acquired seismic data and obtain an image representative of the subsurface region 26. The computing system 60 may use the image to determine locations and/or properties of hydrocarbon deposits. To that end, a variety of seismic data processing algorithms may be used to remove noise from the acquired seismic data, migrate the pre-processed seismic data, identify shifts between multiple seismic images, align multiple seismic images, or the like.

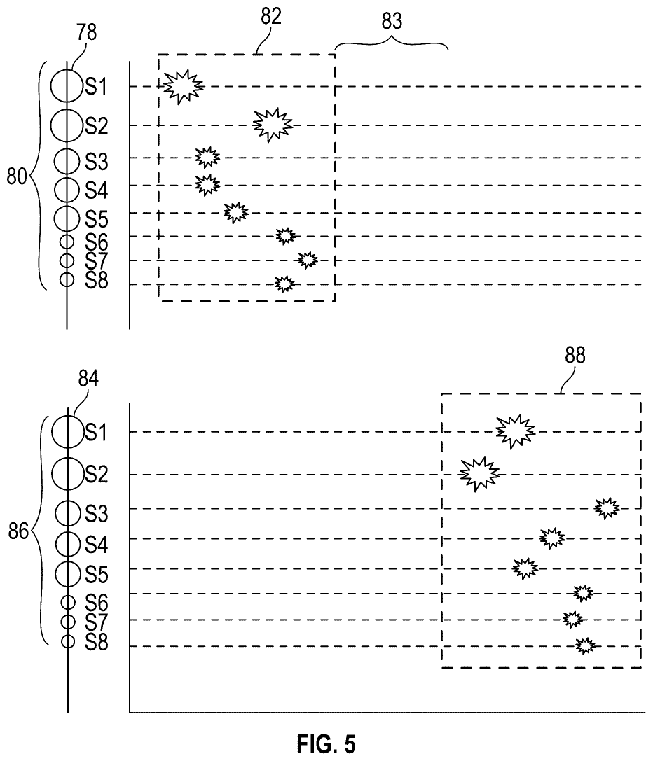

After the computing system 60 analyzes the acquired seismic data, the results of the seismic data analysis (e.g., seismogram, seismic images, map of geological formations, etc.) may be used to perform various operations within the hydrocarbon exploration and production industries. In some embodiments, the computing system 60 may provide an indication of the presence of hydrocarbons. As such, the computing system 60 may provide an indication of the subsurface region 26 that is likely to have hydrocarbons and provide a position (e.g., coordinates or a relative area) of regions that include the hydrocarbon deposits and/or (in some cases) subsurface drilling hazards. In other embodiments, the image generated in accordance with the present techniques may be displayed via the display 72 of the computing system 60, thus facilitating locating a region by a user of the computing system 60. One technique utilized to acquire the seismic data used to provide a seismic data analysis is illustrated in FIG. 5.

FIG. 5 illustrates schematically an embodiment of a technique and system used in seismic acquisition. In general, the technique entails firing seismic sources 78 within a source array 80 (e.g., a seismic source array) according to a firing pattern 82. Thereafter, after a period of time 83, seismic sources 84 within a second source array 86 (e.g., a second seismic source array) are fired according to a second firing pattern 88. In this manner, FIG. 5 illustrates a flip flop shooting technique or method in which one source array 80 is activated (i.e., one or more seismic sources 78 are activated), thereafter, after a period of time 83, the source array 86 is activated (i.e., one or more seismic sources 84 are activated), and thereafter, the process repeats.

It should be noted that each of the firing patterns 82 and 88 are presented for illustrative purposes only and should not be construed as limiting in any way. Moreover, it should be appreciated that while firing pattern 82 differs from firing pattern 88, in some embodiments, the firing of seismic sources 78 and 84 may be duplicated such that firing pattern 82 and firing pattern 88 are a common firing pattern. Likewise, the period of time 83 may be any suitable non-zero time period and may be varied or may remain consistent. When the period of time is varied, the variance can be random, pseudo-random, or according to a pattern.

As illustrated in FIG. 5, the seismic sources 78 and 84 (represented by S1 through S8) are airguns. As illustrated, S1 and S2 represent the same type of large volume airgun, S3 through S5 represent the same type of medium volume airgun, and S6 through S8 represent the same type of small volume airgun. However, it should be noted that any number, volume and type of seismic sources 78 and 84 may be included in each source array 80 and source array 86. For example, the seismic sources 78 may be high frequency sources while the seismic sources 84 are low frequency sources. Indeed, the seismic sources 78 may be any seismic source known to those of skill in the art. For example, one or more of the seismic sources 78 and 84 can be a source which repeatedly emits a single pulse of energy as opposed to a continuous sweep of energy, i.e., an impulsive seismic source. Examples of suitable impulsive seismic sources may include without limitation, airguns, gas guns, water guns, charges, explosives, combinations thereof, and the like. Likewise, other more continuous or non-impulsive sources might also be employed, such as without limitation, vibrators, resonators, sirens, and combinations thereof. Furthermore, it is noted that each of the source array 80 and the source array 86 may represent one of the seismic sources 32 of FIGS. 2 and 3.

The firing patterns 82 and 88 may be generated before a survey is undertaken. The firing patterns 82 and 88 can be loaded onto, for example, one or more controllers that control firing of the seismic sources 78 or 84. Alternatively, the firing patterns 82 and 88 generated in real time during the seismic survey by the one or more controllers. The one or more controllers can, for example, run code or other instructions stored in a memory via a processor of the controller to generate and/or implement the firing patterns 82 and 88. The one or more controllers can be located, for example, on the vessel 30 or may be disposed on or otherwise coupled to the source array 80 and the source array 86. The firing pattern 82 generally comprises a set of random time intervals or delays between the firing (activation) of each seismic source 78. Likewise, the firing pattern 88 generally comprises a set of random time intervals or delays between the firing (activation) of each seismic source 84. An algorithm or program may be used (e.g., by the controller) to generate firing patterns 82 and 88 and seismic signals acquired from these firing patterns 82 and 88 may be processed by any methods known to those of skill in the art.

The firing patterns 82 and 88 may be combined with any suitable simultaneous seismic sourcing or acquisition techniques known to those of skill in the art. Examples of simultaneous seismic shooting techniques include without limitation, independent simultaneous sourcing, self simultaneous sourcing with one or more sources/arrays, firing shots on pre-defined shot point positions (locations) with natural time dithering introduced by varying source boat speed, firing shots with pre-calculated random time dithering, or combinations thereof. In another embodiment, a plurality of arrays may be employed where a first source array 80 is shooting with firing patterns and at least a second source array 86 is shooting with either a self simultaneous sourcing method or with a conventional shooting technique (i.e. same or consistent time delays or period between firing patterns). The source array 80 and source array 86 may be synchronized or unsynchronized with one another. In other embodiments, firing patterns are not used. Instead, two or more source arrays 80 and 86 may be employed where each source array 80 and 86 may each be firing with alternative simultaneous seismic shooting techniques including without limitation, independent simultaneous sourcing, self simultaneous sourcing with one or more sources/arrays, firing shots on pre-defined shot point positions with natural time dithering introduced by varying source boat speed, firing shots with pre-calculated random time dithering, or combinations thereof.

In another exemplary embodiment, source array 80 may be shooting with firing patterns, and at least source array 86 (as well as one or more additional source arrays) may be shooting using an independent simultaneous sourcing technique, where all of the arrays may be synchronized, unsynchronized, random or pseudo-random with respect to one another. It is contemplated that any number of sources and/or source arrays may be used where each source and/or source array may be shooting with any combination of simultaneous sourcing or acquisition techniques such as without limitation, discrete firing patterns, continuous firing patterns, independent simultaneous sourcing, self simultaneous sourcing, or combinations thereof. When a plurality of sources or source arrays are used, each source or source array may also combine different simultaneous shooting techniques, if possible, such as firing patterns in conjunction with self simultaneous sourcing.

As illustrated in FIG. 5, the source arrays 80 and 86 are fired or activated independently of on another. Furthermore, each activation of a source array 80 and 86 may use a different firing pattern. The source arrays 80 and 86 may be coordinated/synchronized with another or unsynchronized. This is a variation of independent simultaneous sourcing. In yet another embodiment, for example, source array 80 may shoot with discrete firing patterns and a source array 86 may shoot with continuous firing patterns.

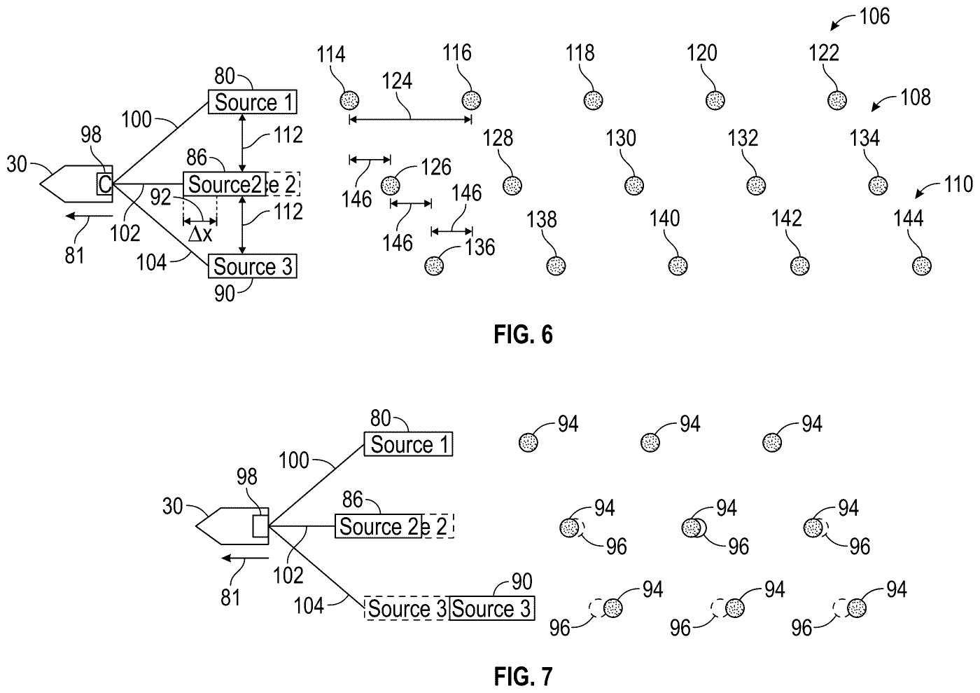

FIG. 6 illustrates marine seismic signal acquisition utilizing a first technique. As illustrated, the vessel 30 is towing three sources (i.e., source array 80, source array 86, as well as source array 90). Source array 90 may be the same or similar to either or both of source array 80 and source array 86 (e.g., a seismic source array). For example, source array 90 can include either seismic sources 78 or seismic sources 84.

Alternatively, source array 90 may include seismic sources that differ in configuration from both seismic sources 78 and seismic sources 84. Additionally, single seismic sources can be utilized in place of any or all of source array 80, source array 86, and source array 90, for example, to improve operation efficiency (i.e., to increase data density and/or reduce operation run time and cost). Furthermore, while three source arrays 80, 86, and 90 are illustrated in FIG. 6, it should be understood that this embodiment is presented for discussion purposes only. Indeed, any “N” number of sources (e.g., source arrays) can be utilized in conjunction with the systems and techniques described herein, wherein N is an integer having a value equal to or greater than one.

Furthermore, one or more of the source arrays 80, 86, and 90 can be horizontally offset (e.g., offset in a horizontal direction 81 parallel to the direction of travel of the vessel 30). For example, as illustrated, source array 86 is horizontally offset by a distance 92 from the position of source array 80 and source array 90 (i.e., the source array 80 and source array 90 are be disposed at a first horizontal distance in the horizontal direction 81 from the vessel 30 and the source array 86 is disposed at a second horizontal distance in the horizontal direction 81 from the vessel 30, whereby a difference in the first horizontal distance and the second horizontal distance is distance 92). That is, the marine survey system 22 and/or the marine survey system 31 can be initially set up to have one or more of the source array 80, the source array 86, and the source array 90 offset from one another along at a distance 92 along in the horizontal direction 81 with respect to the vessel 30 to generate asymmetric geometry of the marine survey system 22 and/or the marine survey system 31. This distance 92 can be a fixed value, for example, approximately 1 meter, approximately 2 meters, approximately 3 meters, or another value or the distance 92 may approximately be between 1 meter and 4 meters, between 1 meter and 3 meters, between 1 meter and 2 meters, between 2 meters and 3 meters, between 2 meters and 4 meters, or another value. Alternatively, the distance 92 may be approximately 10%, 15%, 20%, 25%, 30%, 35%, 40%, 45%, 50%, 55%, 60%, 65%, 70%, 75%, 80%, 85%, 90%, 95% or 100% of a distance in the horizontal direction 81 between the vessel 30 and a selected one of the source arrays 80, 86, and 90.

It should be noted that the offset (e.g., distance 92) may be positive or negative along the horizontal direction 81 with respect to the vessel 30. It should also be noted that the offset can be selected as a relative position between source array 80, source array 86, and source array 90, such that one or more of the source array 80, the source array 86, and the source array 90 may be offset by any given distances, but their achieved relative position is what is determined and implemented. FIG. 7 is illustrative of this concept.

As illustrated in FIG. 7, source array 86 is shifted in a horizontal direction 81 towards the vessel 30 and source array 90 is shifted away from the vessel 30 in the horizontal direction 81. Alternate embodiments in which the source arrays 80, 86, and 90 are shifted with respect to one another and/or with respect to the vessel 30 are contemplated to shift the resulting shot point positions 94 that are generated relative to the shot point positions 96 that would otherwise be generated. Thus, different shifts can be applied to one or more of the source arrays 80, 86, and 90 to produce stronger incoherency of blending noise (i.e., the same shift in distance and/or time need not need be applied to each source array being towed to create more randomness and incoherency of blending noise). The different shifts applied to one or more of the source arrays 80, 86, and 90 may be considered as spatial coding that determines the pattern of blending noise. Every sail line/sequence may share the same spatial code or adopt different spatial codes for each sail line/sequence. Additionally, a controller 98 can generate the control signals in accordance with instructions loaded thereon or the control signals may be determined and generated in real time during the seismic survey by the controller 98. Other examples of these shifting techniques are described in U.S. Provisional Patent Application No. 62/90066 filed Sep. 13, 2019, which is hereby incorporated by reference.

Alternate embodiments of spatial coding can be accomplished by shifting the shot points (e.g., shot point positions 94) instead of shifting position of the source arrays 80, 86, and 90, such that the nominal time (before applying time dithering) between adjacent shots fired by source arrays 80, 86, 90 is not the same. In some embodiments, the technique of shifting shot points (e.g., shot point positions 94) may work together with the concept of shifting the position of source arrays 80, 86 and 90.

Returning to FIG. 6, a controller 98, for example, can control the distance 92 via alteration of a length of tether 102 relative to tether 100 and tether 104 and/or via alteration of the relative position of seismic sources 78 or 84 or sub-arrays within the source array 86 and/or by switching on/off the selective airguns that have different horizontal offsets relative to the center of source array 86 (e.g., when the airguns in the source array 86 are arranged and disposed about a center of the source array 86 in a generally circular or other pattern). For example, a winch or other mechanism may be employed to alter the length of tether 102. The controller 98 (or another control mechanism) can operate to control the winch or other mechanism to adjust the length of the tether 102 to a fixed length. Alternatively, a tether 102 having a length that creates the distance 92 can instead be utilized. A fastener or other connection device may be disposed on or may be part of the source array 86 to couple the tether 102 to the source array 86.

In the illustrated embodiment of FIG. 6, the vessel 30 includes the controller 98, which may operate as described above in conjunction with FIG. 5. Moreover, the vessel 30 may be a portion of marine survey system 22 or marine survey system 31 (i.e., the marine seismic signal acquisition of FIG. 6 can be utilized in conjunction with marine survey system 22 and/or marine survey system 31). The controller 98 may operate to generate and transmit a control signal to the source array 80, the source array 86, and/or the source array 90 to fire (i.e., cause one or more of the seismic sources 78 and 84 therein to be fired), as discussed above in conjunction with FIG. 5. In some embodiments, the controller 98 may include a processor, an integrated circuit, or other electronic processing circuitry capable of executing computer-executable code or instructions to implement the methods described herein. The controller 98 can also include memory, storage, and/or other suitable articles of manufacture that can serve as media to store processor-executable code, data, or the like. These articles of manufacture may represent computer-readable media (e.g., any suitable form of memory or storage) that may store the processor-executable code used by the controller 98 to perform the presently disclosed techniques.

Generally, the controller 98 may execute a software application and/or an algorithm to generate one or more control signals to control the operation (e.g., firing) of the source array 80, the source array 86, and/or the source array 90. In other embodiments, individual controllers 98 can each be dedicated to a respective source array 80, source array 86, and source array 90 to generate one or more control signals to control their respective operation. Furthermore, while three source arrays 80, 86, and 90 are illustrated, more than two sources or arrays may be utilized in conjunction with the techniques described herein.

As illustrated, the vessel 30 tows source array 80 along a shot line 106, source array 86 along shot line 108, and source array 90 along shot line 110. These shot lines 106, 108, and 110 (and, accordingly, the source array 80, 86, and 90) may be a distance 112 apart, for example, 50 meters or another value. Source array 80 fires shots (e.g., at shot point positions 114, 116, 118, 120, and 122) each separated by a distance 124, for example, 24 meters. Likewise, source array 86 fires shots (e.g., at shot point positions 126, 128, 130, 132, and 134) and source array 90 fires shots (e.g., at shot point positions 136, 138, 140, 142, and 144) also separated by distance 124. As illustrated, source array 86 and source array 90 can fire shots between the shots of source array 80. For example, source array 86 can fire a shot at shot point position 126 at a distance 146 from shot point position 114 of the source array 80 and source array 90 can fire a shot at shot point position 136 at a distance 146 from shot point position 126 of the source array 86 and at a distance 146 from shot point position 116 of the source array 80. As illustrated, in the tri-source-array configuration, the distance 146 may be the one third of distance 124, for example, 8 meters when distance 124 is 24 meters, although other values for distance 146 are contemplated.

The controller 98, for example, can cause the source arrays 80, 86, and 90 to fire at desirable and/or predetermined times associated with desired and/or predetermined values for distances 124 and 146. The controller 98 can generate the control signals in accordance with instructions loaded thereon or the control signals may be determined and generated in real time during the seismic survey by the controller 98.

In some embodiments, one or more of the shot point positions 114, 116, 118, 120, and 122, the shot point positions 126, 128, 130, 132, and 134 and the shot point positions 136, 138, 140, 142, and 144 are additionally dithered. That is, the controller 98 generates the control signals so that the actual position of one or more of the shot point positions 114, 116, 118, 120, 122, 126, 128, 130, 132, 134, 136, 138, 140, 142, and 144 are adjusted by a small amount. This amount may be a fraction of a second, for example, between approximately negative 250 ms and positive 250 ms or another value typically less than one second and may cause the actual position of one or more of the shot point positions 114, 116, 118, 120, 122, 126, 128, 130, 132, 134, 136, 138, 140, 142, and 144 to be moved at a dithered distance from the illustrated locations of the shot point positions 114, 116, 118, 120, 122, 126, 128, 130, 132, 134, 136, 138, 140, 142, and 144, whereby, for example, the dithered distance is less than the distance 146. The dithering of the actual position of one or more of the shot point positions 114, 116, 118, 120, 122, 126, 128, 130, 132, 134, 136, 138, 140, 142, and 144 described above are varied and the variance can be random, pseudo-random, or according to a pattern.

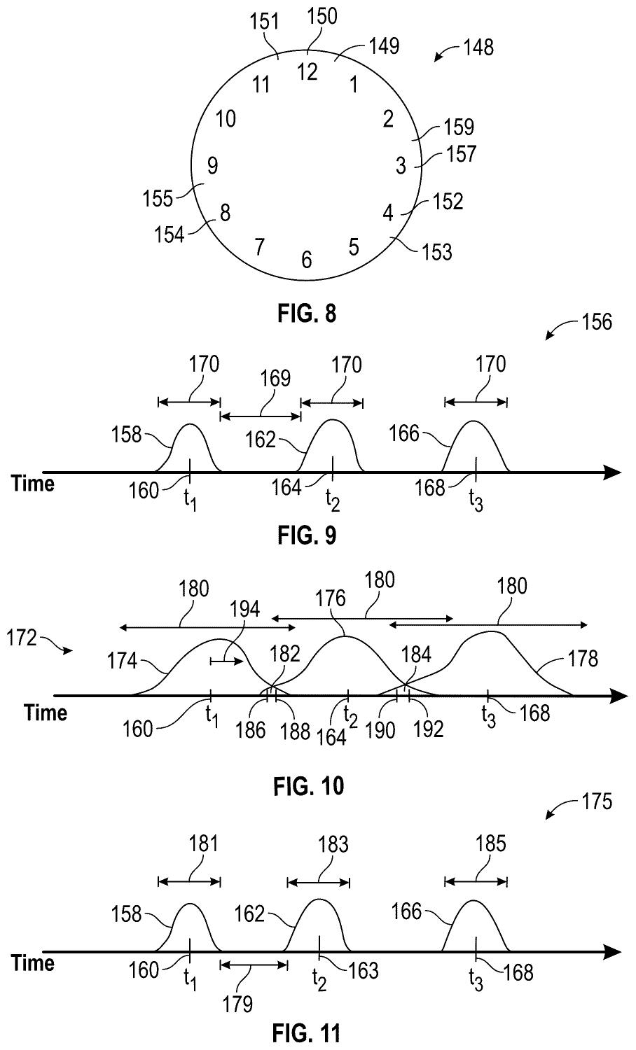

FIG. 8 illustrates a timing diagram 148 that represents times at which a series of shots may be taken. As illustrated, the timing diagram 148 represents shots taken along a twelve second nominal interval (without consideration of varying boat speed) with source array 80, source array 86, and source array 90. However, it should be appreciated that other intervals and/or number of arrays are contemplated and the following description illustrates one embodiment. Thus, in conjunction with FIG. 8, the timing diagram 148 includes, for example, a shot timing 150 that corresponds to shot fired by a source array 80 (e.g., at shot point position 114), a shot timing 152 that corresponds to shot fired by a source array 86 (e.g., at shot point position 126) a shot timing 154 that corresponds to shot fired by a source array 90 (e.g., at shot point position 136). Each of the shot timing 150, the shot timing 152, and the shot timing 154 are separated by four seconds. Additionally, subsequent to shot timing 154, a second shot would be fired by the source array 80 (at shot point position 116) at shot timing 150 and so on for additional shots from the source array 86 and the source array 90. The shot timing 150, shot timing 152, and shot timing 154 also determine the distance 146 between the shot point position 114, the shot point position 126, and the shot point position 136 (e.g., based on the speed of the vessel 30 and, accordingly, its distance traveled between the shot fired by the source array 80, the source array 86, and the source array 90).

It would be advantageous to increase the amount of sampling of source positions (e.g., shots at shot point positions 114, 116, 126, 128, 136, 138, etc.) in a seismic survey. As previously described, there may be a shot point (e.g., the shot at shot point position 114), for example, every 24 meters (at distance 112 apart from the shot at shot point position 116) in a direction along the horizontal sailing direction (e.g., the sail line in the horizontal direction 81) of the vessel 30. Likewise, for example, shot points (e.g., the shot at shot point position 114 and the shot at shot point position 126) are separated by distance 112 (e.g., 50 meters or another value) in a direction orthogonal to the direction along the horizontal sailing direction of the vessel 30. However, there may be limits to increasing the amount of sampling of source positions in a seismic survey.

For example, it is desirable to generate seismic records (e.g., seismic recordings) to have a predetermined amount of time (e.g., at least a certain amount of time or a sufficient amount of time) of recording of the reflected waves. Firing of additional seismic sources 32 during a recording of a given record generates interference in the recording, which is generally undesirable. Likewise, it is generally undesirable to fire a seismic source 32 (e.g., source array 90) as a reflected wave from a previously fired seismic source 32 (e.g., source array 80) is being received and/or recorded. For example, shot timing 150 corresponds to shot fired by a source array 80 (e.g., at shot point position 114) and it takes eight seconds for the reflected wave to be received, this eight seconds corresponds to shot timing 154 in which a shot is being fired by the source array 90 (e.g., at shot point position 136). The firing of a shot as a reflected wave is being received can cause issues in the recording of the reflected wave. That is, insufficiently random timing between sources fired from the same vessel 37 can operate to generate unwanted interference in the data when the correct time references are applied and lead to incompletely deblended seismic records.

One technique to alleviate and/or eliminate the overlap in reflected wave reception with subsequent shots includes adjusting the timing of shot timing 150, shot timing 152, and/or shot timing 154. Thus, instead of firing shots at shot timing 150, shot timing 152, and shot timing 154 (each exactly four seconds apart), the timing of shot timing 150, shot timing 152, and/or shot timing 154 may be adjusted (e.g., dithered) by, for example, a random amount of time. The adjustment might instead be a fixed amount of time.

Through the use of dithering, one or more of the shot timing 150, shot timing 152, and/or shot timing 154 will be adjusted so that they are not exactly four seconds apart. For example, the shot timing 150 may be adjusted 0.25 seconds earlier to shot timing 151, the shot timing 152 may be delayed by 0.4 seconds to shot timing 153, and the shot timing 154 may be delayed by 0.8 seconds to shot timing 155 so that when reflected waves are received (e.g., eight second after a shot is issued), the interfering shots are not synchronized with other shots, such that the energy appears to be incoherent and can be separated through processing.

In one technique, the dithering (e.g., adjustment) values may be limited to a particular range. FIG. 9 illustrates a shot diagram 156 that includes a shot timing distribution 158 centered about a timing value 160 (t₁), where the timing value 160 corresponds to, for example, shot timing 150 of source array 80. The shot diagram 156 further includes a shot timing distribution 162 centered about a timing value 164 (t₂), where, for example, the timing value 164 corresponds to shot timing 152 of source array 86 and a shot timing distribution 166 centered about a timing value 168 (t₃) where the timing value 168 corresponds to shot timing 154 of source array 90. As illustrated, the distribution of timing values available in each of the shot timing distribution 158, the shot timing distribution 162, and the shot timing distribution 166 extends a distance 170, which may be, for example, approximately 25% or less of the time between successive shots. For example, the distance 170 may be in total approximately one second or less, which corresponds to, for example, a 0.5 second advance or delay around each of the timing value 160, the timing value 164, and the timing value 168.

Notice that despite the implementation of shot adjustment (dithering) is described in time, it is easily replaceable with spatial adjustment (dithering) as a factor of boat speed. For example, given the boat travelling at 2 m/s, a 0.5 second advance or delay is equivalent to 1m advance or delay spatially.

It should be noted that both the distance 170 may be increased or decreased and, in some embodiments, the distance 170 need not be centered about any of the timing value 160, the timing value 164, and the timing value 168. Moreover, randomly selected timing values (e.g., a randomly selected delay or advance of the firing times) need not be distributed in a Gaussian manner. The randomly selected timing values can be generated on the fly (e.g., during or just as a seismic survey is undertaken), for example, by the controller 98 or may be received by the controller 98 on the fly. Alternatively, the sequence of shot timings may be pre-loaded onto or calculated by the controller 98, for example, prior to initiation of a seismic survey and/or when a seismic survey is initially plotted.

By using randomly selected timing values in one or more of the shot timing distribution 158, the shot timing distribution 162, and the shot timing distribution 166 (in place of one or more of the shot timing 150, shot timing 152, and the shot timing 154), overlaps in transmission of a shot with reception of a reflected wave may be minimized. Use of randomization in selection of the timing values allows for better separation of the seismic sources 32 when seismic processing of the recordings is undertaken, leading to an improved image. The time interval 169 between shots is defined by the interval between shot 160, 164 & 168, and the shot timing distribution 158, 162 & 166. In seismic acquisition, due to the time it takes the controller 98 to acquire the current locations of the sources, estimate the timing of the next shot and send the firing signal to airguns, it may take 2 or 3 seconds to ensure the next shot is fired properly. When the distance between shots is reduced (the sizes of the shot timing between 160, 164 and 168 are reduced) and/or when the spatial coding is applied to the source position or shot point positions, the timing distribution 158, 162 and 166 may have to be reduced to ensure the time interval 169 between shots is large enough to the airgun devices to cycle through for the next shot.

When the spatial coding is applied, the nominal shot interval is changed to maximize the randomness of the interference energy. For example, in FIG. 7 the shot timing 152 of source array 86 is moved to 157, one second ahead of original shot timing 152. It can be achieved by either moving the source array 86 forward by 2 meters or shot point position 126 backward by 2 meters, assuming 2 m/s boat speed. If a 0.5 second dither is applied move to shot timing of source array 80 from 150 to 149, and a −0.5 second dither is applied to source array 86 to move shot timing from 157 to 159, the shot time interval between source array 80 and source array 86 is 2 seconds, which may fall below the minimum time interval needed for the airgun to generate proper shot.

FIG. 10 illustrates a shot diagram 172 that includes a shot timing distribution 174 centered about timing value 160, a shot timing distribution 176 centered about timing value 164, and a shot timing distribution 178 centered about timing value 168. As illustrated, the distribution of timing values available in each of the shot timing distribution 158, the shot timing distribution 162, and the shot timing distribution 166 extends a distance 180, which may be, for example, approximately 50% or more of the time between successive shots. For example, the distance 180 may be in total approximately two seconds or more, which corresponds to, for example, a one second or more advance or delay around each of the timing value 160, the timing value 164, and the timing value 168.

It should be noted that both the distance 180 may be increased or decreased and, in some embodiments, the distance 180 need not be centered about any of the timing value 160, the timing value 164, and the timing value 168. Moreover, randomly selected timing values (e.g., a randomly selected delay or advance of the firing times) need not be distributed in a Gaussian manner. The randomly selected timing values can be generated on the fly (e.g., during or just as a seismic survey is undertaken), for example, by the controller 98 or may be received by the controller 98 on the fly. Alternatively, the sequence of shot timings may be pre-loaded onto or calculated by the controller 98, for example, prior to initiation of a seismic survey and/or when a seismic survey is initially plotted.

While there are benefits to increasing from distance 170 in the shot diagram 156 to distance 180 in the shot diagram 172, additional problems may also occur. FIG. 10 illustrates overlap region 182 and overlap region 184. Overlap region 182 includes timing values from the shot timing distribution 174 that overlap with and/or are adjacent to timing values from the shot timing distribution 176 (e.g., within a predetermined amount of time). Likewise, overlap region 184 includes timing values from the shot timing distribution 176 that overlap with and/or are adjacent to timing values from the shot timing distribution 178. Thus, a shot timing 186 that corresponds to a shot fired by a source array 80 with a delay of approximately 1.9 seconds may be selected as a random timing value and a shot timing 188 that corresponds to an immediately subsequent shot fired by a source array 86 with an advance of approximately 2 seconds may be selected as a random timing value. Similarly, a shot timing 190 that corresponds to a shot fired by a source array 86 with a delay of approximately 1.8 seconds may be selected as a random timing value and a shot timing 190 that corresponds to an immediately subsequent shot fired by a source array 90 with an advance of approximately 2.1 seconds may be selected as a random timing value. The proximity of these shots from separate seismic sources 32 (i.e., source array 80 and source array 86 or source array 86 and source array 90) may negatively influence the operation of the seismic sources 32. For example, the seismic sources 32 may include a pressurized pneumatic system that is affected when the seismic sources 32 (especially when isolated for independent firing) are fired within a predetermined time of one another. Thus, while it is desirable to increase the distance 180 relative to distance 170, sequential firings within a predetermined amount of time (e.g., adjacent sequential firings) from seismic sources 32 (e.g., source array 80 and source array 86) that overlap and/or are adjacent to one another (e.g., when shot timing 186 and shot timing 188 are present in overlap region 182) may not be allowed. The occurrence of sequential firings that overlap and/or are adjacent to one another can also increase as the number of seismic sources 32 increase.

With the implementation of spatial coding of source position or shot point position, FIG. 11 illustrates a shot diagram 175 that is like the shot diagram 156, except that the center of the shot time of timing value 164 is moved closer to the shot time of timing value 160. If the shot interval between 160, 164 and 168 is 4 second, and the timing distribution (corresponding to distance 170) is between −0.5 second and 0.5 second, the (minimum shot) time interval 169 is 3 seconds. However, when the center of shot time 164 is moved by 1 second to 163, the (minimum) shot time interval 179 is reduced to 2 seconds, which may be out of the specification of source devices. Thus, FIG. 11 illustrates a technique to eliminate conflicts in firings with respect to, for example, the second shot diagram of FIG. 9 or 10.

One technique to eliminate conflicts in firings with respect to shot timing distribution 158, shot timing distribution 162, and shot timing distribution 166 is by adopting different time adjustment ranges for 181, 183, and 185. For example, in FIG. 9 the time adjustment (dithering) range (as distance 170) for shot timing distribution 158, shot timing distribution 162 and shot timing distribution 166 is 1 second. To avoid conflicts after applying spatial coding, the time adjustment range 181 for source 80 and the time adjustment range 183 for source 86 may be reduced to 500 milliseconds, and the time adjustment range 185 for source array 90 may be increased to 1500 milliseconds to keep the shot time interval 179 at 2.5 seconds or above. However, if the source devices require minimum shot time interval bigger than the time between shot time 160 and shot time 163, the following technique or the combination the following technique and the currently described technique can be used to eliminate the conflicts.

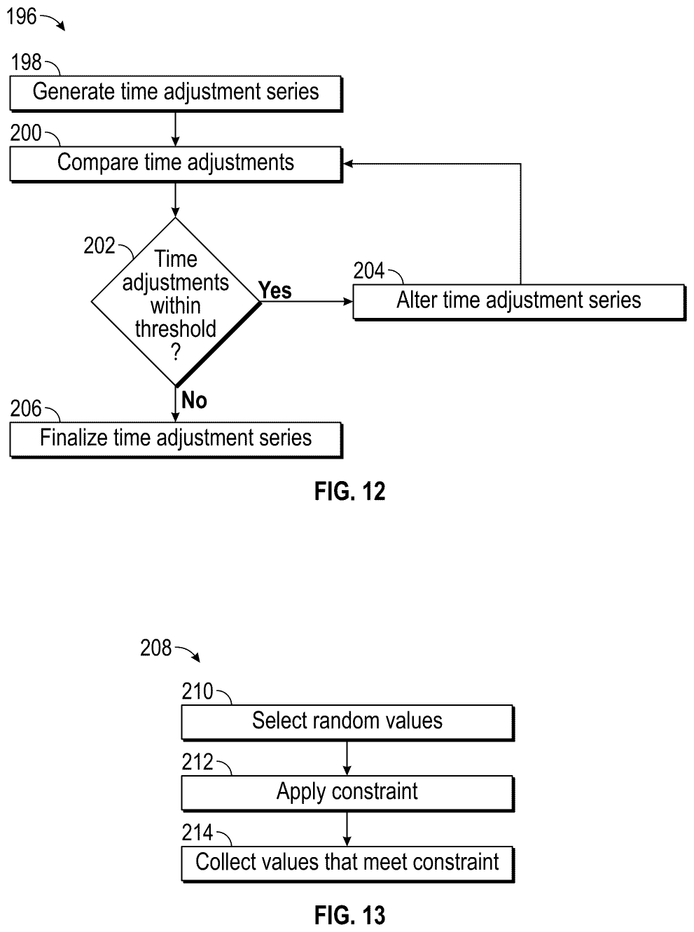

Another technique to eliminate conflicts in firings with respect to shot timing distribution 174, shot timing distribution 176, and shot timing distribution 178 is described below in conjunction with the method 196 of FIG. 12. In step 198, a computer system (e.g., the computing system 60 or the controller 98) may run a program stored in computer readable media (e.g., memory 66 or other storage) to generate a series of random time adjustments for each of the seismic sources 32. For example, r₁ (Δt₁, Δt₁, Δt₁, . . . , Δt₁) may be the calculated (i.e., generated) random time adjustment series for source array 80 and each instance of Δt₁ is a randomly selected timing value in the shot timing distribution 174. The randomly selected timing value in the shot timing distribution 174 (or another predetermined shot timing distribution) can be generated or otherwise calculated as having a maximum advance and delay about timing value 160. Similarly, for example, r₂ (Δt₂, Δt₂, Δt₂, . . . , Δt₂) may be the calculated (i.e., generated) time adjustment series for source array 86 and each instance of Δt₂ is a randomly selected timing value in the shot timing distribution 176. The randomly selected timing value in the shot timing distribution 176 (or another predetermined shot timing distribution) can be generated or otherwise calculated as having a maximum advance and delay about timing value 164. Likewise, for example, r₃ (Δt₃, Δt₃, Δt₃, . . . , Δt₃) may be the calculated (i.e., generated) time adjustment series for source array 90 and each instance of Δt₃ is a randomly selected timing value in the shot timing distribution 176. The randomly selected timing value in the shot timing distribution 176 (or another predetermined shot timing distribution) can be generated or otherwise calculated as having a maximum advance and maximum delay about timing value 168 as part of step 198.

The computer system (e.g., the computing system 60 or the controller 98), in step 200, may run a program stored in computer readable media (e.g., memory 66 or other storage) to compare the pairs of the generated series of random time adjustments for each of the seismic sources 32 to whether the pair occurs within a predetermined amount of time (i.e., whether the timing of random time adjustment results in shots within a threshold amount of time with respect to one another). For example, the first randomly selected timing value Δt₁ in the shot timing distribution 174 of the time adjustment series r₁ is compared with the first randomly selected timing value Δt₂ in the shot timing distribution 176 of the time adjustment series r₂ and the first randomly selected timing value Δt₃ in the shot timing distribution 178 of the time adjustment series r₃ so as to determine if their timings occur within a predetermined amount of time with respect to one another. The computer system (e.g., the computing system 60 or the controller 98) as part of the program stored in computer readable media (e.g., memory 66 or other storage), in step 202, determines if the first randomly selected timing values Δt₁, Δt₂, and Δt₃ correspond to shots occurring within a predetermined amount of time with respect to one another (e.g., overlap with and/or are adjacent to one another, which may be a preselected threshold value or may be otherwise chosen, such as, more than 2 seconds apart). If the first randomly selected timing values Δt₁, Δt₂, and Δt₃ correspond to shots occurring within a predetermined amount of time with respect to one another in step 202 (e.g., are less than or are less than or equal to the predetermined threshold), then the computer system (e.g., the computing system 60 or the controller 98) as part of the program stored in computer readable media (e.g., memory 66 or other storage) in step 204, operates to remove (e.g., delete) one or more of the first randomly selected timing values Δt₁, Δt₂, and Δt₃ from the time adjustment series r₁, r₂, and r₃ (e.g., eliminate or otherwise delete pairs of selected timing values Δt₁, Δt₂, and Δt₃ that do not meet a predetermined criteria, such as a time between the timing values Δt₁, Δt₂, and Δt₃ being less than a threshold value). The process moves to step 200 again to be repeated for remaining pairs of randomly selected timing values Δt₁, Δt₂, and Δt₃ from the time adjustment series r₁, r₂, and r₃, with last selected Δt₃ carried over to the next step to ensure the Δt₁ from the next step and the last Δt₃ is separated by a predetermined amount of time or more.

In another embodiment, the computer system (e.g., the computing system 60 or the controller 98) as part of the program stored in computer readable media (e.g., memory 66 or other storage) in step 204 replaces whichever selected timing value of the compared pairs of randomly selected timing values caused the failure of the randomly selected timing values with a value that would not yield a result less than the predetermined amount of time with one another (e.g., a preselected threshold value, such as 2 seconds, 1.5 seconds, or another value). In this manner, instead of removing the one or more of the first randomly selected timing values Δt₁, Δt₂, and Δt₃ from the time adjustment series r₁, r₂, and r₃ that causes an issue when compared as a paired value in the manner described above with regards to step 204, the timing values Δt₁, Δt₂, and Δt₃ are replaced (e.g., modified as modified pairs of timing values) in step 204 to have a value that does not cause a failure, i.e., as a pair the timing values correspond to shots that are chosen not to overlap with and/or are adjacent to one another, which may be a preselected threshold value or may be otherwise chosen. Once no pairs need further adjustment (i.e., all time adjustments are outside of the threshold in step 202), the method 196 proceeds to step 206.

In step 206, the computer system (e.g., the computing system 60 or the controller 98) as part of the program stored in computer readable media (e.g., memory 66 or other storage) generates a finalized (e.g., revised) time adjustment series for source array 80, r₁ (Δt₁, Δt₁, Δt₁, . . . , Δt₁), for source array 86, r₂ (Δt₂, Δt₂, Δt₂, . . . , Δt₂), and for source array 90, r₃ (Δt₃, Δt₃, Δt₃, . . . , Δt₃) that do not include pairs of timing values Δt₁, Δt₂, and Δt₃ that conflict with one another and the Δt₁ from current pair does not conflict with the Δt₃ from previous pair (i.e., timing values Δt₁, Δt₂, and Δt₃ that not to overlap with and/or are adjacent to one another, which may be a preselected threshold value or may be otherwise chosen). These selected pairs exceed the predetermined amount of time with respect to one another in step 202 (e.g., are greater than or are greater than or equal to the predetermined threshold). This finalized time adjustment series can be transmitted to or otherwise loaded into the controller 98 (e.g., preloaded) as an additional parameter to set a firing schedule to control timing of the firing of shots from the source array 80, the source array 86, and the source array 90. Alternatively, the finalized time adjustment series can be transmitted to or otherwise loaded into the controller 98 in real time or in near real time (e.g., on the fly) as a firing schedule for the vessel 30, for example, as the vessel 30 is sailing in a horizontal direction 81 (e.g., along the sail line in the horizontal direction 81).

Regardless of whether the computer system (e.g., the computing system 60 or the controller 98) removes entirely or replaces timing values Δt₁, Δt₂, and Δt₃ from the time adjustment series r₁, r₂, and r₃, the result is a generated time adjustment series r₁, r₂, and r₃ in step 206 that include timing values Δt₁, Δt₂, and Δt₃ that do not overlap with and/or are not adjacent to one another (i.e., timing values Δt₁, Δt₂, and Δt₃ that as a pair are less than a preselected threshold value apart from one another, such as 2 seconds apart or another value as a constraint value “x”). This provides a set of randomized timing values Δt₁, Δt₂, and Δt₃ that improve the separability of the interfering shots that are fired before the previous shot finishes recording and the firing of a shot as a reflected wave is being received, which can cause issues in the recording of the reflected wave. Additionally, by generating a set of randomized timing values Δt₁, Δt₂, and Δt₃ that improve the separability of the interfering shots that are fired and the firing of a shot as a reflected wave is being received, the distance 180 (relative to distance 170) can be utilized (i.e., greater dithering values may be utilized) that allow for increases in resolution in seismic data generated from the received seismic signals. That is, when greater dithering values are utilized, the received data can be better recovered from the interference of other seismic data, thus allowing for a cleaner (i.e., higher resolution) seismic analysis to be generated on the received seismic data.

Another embodiment for comparison and removal of overlapping and/or adjacent timing values is illustrated by the method 208 of FIG. 13. In step 210, the computer system (e.g., the computing system 60 or the controller 98) running a program that considers a random variable (e.g., the randomly selected timing values) as an nth grouping (where “n” is a positive integer) corresponding to the number of seismic sources 32 (or the number of source arrays, for example, source array 80, source array 86, and source array 90). For example, in the case of three source arrays 80, 86, and 90, the computer system (e.g., the computing system 60 or the controller 98) considers the random variable (e.g., the randomly selected timing values) as a triplet of timing values (e.g., Δt₁, Δt₂, Δt₃) together taken as a vector (e.g., a vector random number) in accordance with step 210.

More particularly, the vector is a constrained vector where the constraint is that each of Δt₁, Δt₂, Δt₃ fall within a distribution (e.g., shot timing distribution 174, shot timing distribution 176, and shot timing distribution 178) such that each of Δt₁, Δt₂, Δt₃ has a probability, respectively, centered around the timing value 160, the timing value 164, and the timing value 168 (or another value) as well as a standard deviation 194 that can be predetermined (and which may be the same value or can differ for each of Δt₁, Δt₂, Δt₃). Thus, in step 212, the computer system (e.g., the computing system 60 or the controller 98) can initiate a program to apply the predetermined constraint. For example, this may include generating random numbers subject to the constraint in Equation 1 below:

$$Δ {t}_{2} - Δ {t}_{1} \geq x - {t}_{21} ⋁ Δ {t}_{3} - Δ {t}_{2} \geq x - {t}_{32} ⋁ Δ {t}_{1} - Δ {t}_{3}^{′} \geq x - {t}_{13} \qquad ( Equation 1 )$$

Equation 1 illustrates an example of a constraint in which for every vector generated of randomly selected timing values, the absolute value of the difference of any of (Δt₁ and Δt₂) or (Δt₂ and Δt₃) or (Δt₃ and Δt₁) should be greater than or equal to (or alternatively, greater than) a constraint value “x” minus the nominal time it takes between the time source array 80 arrives at shot point position 114 and the time source 86 arrives at shot point position 126 (t₂₁), the nominal time it takes between the time source 86 arrives at shot point position 126 and the time source array 90 arrives at shot point position 136 (t₃₂) or the nominal time it takes between the time source array 90 arrives at shot point position 136 and the time source 80 arrives at shot point position 114 (t₁₃); herein, the superscription Δt₃ indicates the time adjustment value for source array 90 from previous step, and a predetermined chosen threshold time value as the constraint value “x” (e.g., a threshold amount of time between shots, such as 2.5 second or another number). This results in the difference in firing times between sequential shots being larger than the selected threshold amount of time, i.e., the constraint value “x”. In some embodiments, the constraint value “x” may be determined by physical characteristics of the source array 80, the source array 86, and the source array 90, such as, how a pressurized pneumatic system is affected when seismic sources 32 are fired within a predetermined time of one another. That is, the constraint value “x” may be chosen as a minimum value or other value between the firing times of seismic sources 32.

It should be noted that steps 210 and 212 may be repeated to generate additional constrained vectors. In this manner, the computer system (e.g., the computing system 60 or the controller 98) operates as a constrained random number generator that generates a series of vectors having “n” values (where “n” is a positive integer that corresponds to the number of seismic sources 32) that meet the requirements of Equation 1 (or another applied constraint). Thereafter, in step 214, the computer system (e.g., the computing system 60 or the controller 98) running a program collects the resultant vectors that are generated as meeting the requirements of Equation 1 (or another constraint that is applied in step 212). These collected resultant vectors correspond to a finalized time adjustment series that can be transmitted to or otherwise loaded into the controller 98 (e.g., preloaded) as an additional parameter to set the firing schedule to control timing of the firing of shots from the source array 80, the source array 86, and the source array 90. Alternatively, the finalized time adjustment series can be transmitted to or otherwise loaded into the controller 98 in real time or in near real time (e.g., on the fly) as an additional parameter to set the firing schedule for the vessel 30, for example, as the vessel 30 is sailing in a horizontal direction 81 (e.g., along the sail line in the horizontal direction 81).

Through implementation of the method 208, every vector of randomly selected timing values collected in step 214 is ensured to be a constrained vector (e.g., meets Equation 1 or another predetermined defined constraint) and does not correspond to shots that would negatively affect the operation of the seismic sources 32, while still allowing for larger shot timing distributions, even allowing for use of shot timing distributions that overlap (e.g., shot timing distribution 174, shot timing distribution 176, and shot timing distribution 178) without a possibility of sequential shots occurring in overlap region 182 and overlap region 184. In this manner, implementation of the method 208 (as well as method 196) by a computer system (e.g., the computing system 60 or the controller 98) operates to preclude undesirable timing of sequential shots while still providing for improvements in the recovered seismic data (through the use of increases in the randomized interference generated) when the sizes of shot timing distributions are increased (e.g., shot timing distribution 174, shot timing distribution 176, and shot timing distribution 178) to be adjacent to one another (e.g., within a predetermined amount of time of one another, such as the constraint value “x”) and/or when spatial coding is to the source position or shot position.

Use of the method 196 or the method 208 allows for the larger shot timing distributions while preventing undesirable timing of sequential shots (e.g., shots that overlap with and/or are adjacent to one another, such as shots within a preselected threshold value of approximately 2 seconds, 2.5 seconds, or another value). If constraint of timing values (such as those described in method 196 or method 208) are not employed, timing distributions that are adjacent or overlap can include timing values that are within the preselected threshold value, which may cause the controller 98 to reject a requested firing pattern from being performed so as to preserve the pressurized pneumatic system by precluding firings of seismic sources 32 within a predetermined time of one another).

It should be noticed despite the description above uses shot intervals t₂₁ t₃₂ and t₁₃ plus shot time adjustments Δt₁ Δt₂ and Δt₃ to determine the firing time of the sources, it is easy to modify the Equation 1 to include the shot intervals into shot time adjustments, by shifting the center of the distribution from 0 to t₂₁ t₃₂ or t₁₃. As the vessel speed may vary during operation, the shot intervals t₂₁, t₃₂ and t₁₃ could use predetermined values based on the distance between shots and a nominal vessel speed, or determined dynamically during the operation with the actual time it takes for the sources to arrive the desired source point locations.

While the present embodiments have been described in conjunction with shots in pairs (i.e., sequential shots) with respect to time, it should be appreciated that a similar process can be applied to shots in pairs with respect to distances. For example, as discussed above with respect to FIG. 7, one or more of the source array 80, the source array 86, and the source array 90 can be shifted in a horizontal direction 81 towards or away from the vessel 30. This results in corresponding shifts to the resulting shot point positions 94 that are generated relative to the shot point positions 96 that would otherwise be generated. By shortening or lengthening the distances between the vessel 30 and one or more of the source array 80, the source array 86, and the source array 90 in the horizontal direction 81, there is a resultant change in the timing of the shots of the one or more of the source array 80, the source array 86, and the source array 90 (i.e., a timing advance or delay built in due to the respective shortening or lengthening of the distance between the vessel 30 and one or more of the source array 80, the source array 86, and the source array 90 in the horizontal direction 81).

This generates, in effect, a time dither based on the shift and operates to shift the shot timing distribution 158, shot timing distribution 162, and shot timing distribution 166 and/or shot timing distribution 174, shot timing distribution 176, and shot timing distribution 178. That is, the timing value 160 the timing value 164, and the timing value 168, as the respective centered positions of the shot timing distribution 158, shot timing distribution 162, and shot timing distribution 166 and/or shot timing distribution 174, shot timing distribution 176, and shot timing distribution 178 may respectively advanced and/or delayed. For example, advance of the timing value 160 (e.g., moving the timing value 160 and, accordingly, the shot timing distribution 158 and/or the shot timing distribution 174 to an earlier time) can correspond to a shorting of the tether 100. Likewise, for example, delay of the timing value 164 (e.g., moving the timing value 164 and, accordingly, the shot timing distribution 162 and/or the shot timing distribution 176 to a later time) can correspond to a lengthening of the tether 102. Either of these adjustments may be accompanied by an alteration (delay or advance) of the timing value 168 or, alternatively, the timing value 168 and/or either of the timing value 160 and the timing value 164 may remain unadjusted (corresponding to no relative lengthening or shortening of their respective tethers 100, 102, and 104).

Thereafter, removal of undesirable timing of sequential shots (e.g., through the application of method 196, method 208, or another timing value removal or adjustment technique) can be applied to remove or alter shots that would otherwise overlap with and/or be adjacent to one another, such as shots within a preselected threshold value of approximately 2 seconds, 2.5 seconds, or another value. This will still provide improvements in the recovered seismic data (through the use of increases in the randomized interference generated) when the sizes of shot timing distributions are increased (e.g., shot timing distribution 174, shot timing distribution 176, and shot timing distribution 178) to be adjacent to one another or even overlap, even after being shifted due to the spatial change in the distance between the vessel 30 and one or more of the source array 80, the source array 86, and the source array 90 in the horizontal direction 81.

Technical effects of this disclosure include systems and methods for alteration of seismic acquisitions. The techniques include broadening a range of potential dithering times that can be applied to a series of seismic shots. The distribution of random dithering times may be adjacent to one another between two sequential shots (e.g., a pair of shots) or even overlap in their distributions so as to extend the potential shot timing distributions that are available. The range of the random dithering time can vary between different sources. However, selection of particular timing values are checked to insure that any two pairs of shots do not interfere with one another (i.e., pairs of selected timing values Δt₁, Δt₂, and Δt₃ are checked to meet a predetermined criteria, such as a time between the timing values Δt₁, Δt₂, and Δt₃ being less than a threshold value). Timing values that do not meet the predetermined criteria are removed or modified so that they meet the predetermined criteria. In this manner, even when distribution of random dithering times between shots overlap, any two sequential shots are checked to insure that they do not overlap and/or are not adjacent to one another, such as shots within a preselected threshold value of approximately 2 seconds, 2.5 seconds, or another value. Resulting gathers after deblending may be relatively clean gathers (in comparison to a gather that was not generated via the disclosed techniques) that may be used both for imaging, prestack analysis such as AVO (Amplitude vs. Offset) analysis, and velocity-model building, for example, by Full-Waveform Inversion (FWI). Thus, these recovery and processing operations described herein may cause improved data inputs into seismic image generators. When data inputs into the seismic image generators are improved, the resulting seismic image may also improve, causing an improvement of a representation of hydrocarbons in a subsurface region of Earth or of subsurface drilling hazards.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A method, comprising:
firing a first source array at a first time of a first shot timing distribution comprising first time values according to a firing schedule; and
firing a second source array at a second time of a second shot timing distribution comprising second time values subsequent to firing the first source array and prior to another firing of the first source array according to the firing schedule, wherein at least a portion of the second shot timing distribution overlaps with the first shot timing distribution or the at least a portion of the second shot timing distribution is separated from the first shot timing distribution by less than a predetermined period of time, wherein the first time and the second time of the firing schedule are separated by at least the predetermined period of time.

2. The method of claim 1, comprising firing the first source array at a third time of the first shot timing distribution comprising the first time values subsequent to firing the second source array at the second time according to the firing schedule, wherein the third time and the second time of the firing schedule are separated by at least the predetermined period of time.

3. The method of claim 1, comprising firing a third source array at a third time of a third shot timing distribution comprising third time values subsequent to firing the second source array and prior to the another firing of the first source array according to the firing schedule, wherein at least a portion of the third shot timing distribution overlaps with the second shot timing distribution or the at least a portion of the third shot timing distribution is separated from the second shot timing distribution by less than the predetermined period of time, wherein the third time and the second time of the firing schedule are separated by at least the predetermined period of time.

4. The method of claim 3, wherein the first time, the second time, and the third time of the firing schedule comprise a constrained vector of timing values.

5. The method of claim 3, wherein the first shot timing distribution, the second shot timing distribution, and the third shot timing distribution share the same probability distribution function.

6. The method of claim 3, wherein the first shot timing distribution, the second shot timing distribution, and the third shot timing distribution share different probability distribution functions.

7. The method of claim 1, wherein the firing schedule is loaded into a controller of a vessel towing the first source array and the second source array prior to movement of the vessel along a shot line of a seismic acquisition.

8. The method of claim 1, wherein the firing schedule is calculated in conjunction with movement of a vessel along a shot line of a seismic acquisition.

9. The method of claim 8, comprising towing the first source array and the second source array behind the vessel.

10. The method of claim 1, comprising:
positioning the first source array at a fixed first distance from a vessel towing the first source array and the second source array; and
positioning the second source array at a fixed second distance from the vessel, wherein the fixed second distance differs from the fixed first distance.

11. The method of claim 10, comprising:
utilizing a tether having a first length to position the first source array at the fixed first distance from the vessel; and
utilizing a second tether having a second length to position the second source array at the fixed second distance from the vessel.

12. The method of claim 10, comprising altering a length of a tether coupled to the second source array to position the second source array at the fixed second distance from the vessel.

13. The method of claim 10, comprising altering a length of a tether coupled to a third source array to position the third source array at a fixed third distance from the vessel.

14. The method of claim 10, comprising:
selecting a first group of seismic sources within the first source array that have a first offset distance from a center of the first source array along the shot line direction; and
selecting a second group of seismic sources within the second source array that have a second offset distance from a center of the second source array along the shot line direction.

15. The method of claim 14, wherein the second offset distance from the center of the second source array is different from the first offset distance from the center of the first source array.

16. The method of claim 1, comprising:
disposing the first source array comprising a plurality of seismic sources over a seismic survey region prior to firing the first source array; and
disposing the second source array comprising a second plurality of seismic sources over the seismic survey region prior to firing the second source array.

17. A tangible and non-transitory machine readable medium, comprising instructions to:
generate a first shot timing distribution comprising first time values to fire a first source array;
generate second shot timing distribution comprising second time values to fire a second source array, wherein at least a portion of the second shot timing distribution overlaps with the first shot timing distribution or the at least a portion of the second shot timing distribution is separated from the first shot timing distribution by less than a predetermined period of time;
generate a time adjustment series comprising a plurality of pairs of timing values selected from each of the first time values and the second time values;
compare each pair of timing values of the plurality of pairs of timing values against a threshold value; and
generate a finalized time adjustment series comprising selected pairs of timing values of the plurality of pairs of timing values that exceed the threshold value.

18. The tangible and non-transitory machine readable medium of claim 17, comprising instructions to delete any pairs of timing values of the plurality of pairs of timing values that are less than the threshold value or are less than or equal to the threshold value.

19. The tangible and non-transitory machine readable medium of claim 17, comprising instructions to modify any pairs of timing values of the plurality of pairs of timing values that are less than the threshold value or are less than or equal to the threshold value by adjusting at least one of a respective first time value of the first time values and a respective second time value of the second time values of each of the any pairs of timing values of the plurality of pairs of timing values to generate modified pairs of timing values.

20. The tangible and non-transitory machine readable medium of claim 19, comprising instructions to:
compare the modified pairs of timing values against the threshold value; and
generate the finalized time adjustment series as additionally comprising selected modified pairs of timing values of the modified pairs of timing values that exceed the threshold value.

21. The tangible and non-transitory machine readable medium of claim 17, comprising instructions to transmit the finalized time adjustment series as a firing schedule of a vessel corresponding to the first source array and the second source array.

22. A tangible and non-transitory machine readable medium, comprising instructions to:
select timing values as a set of timing values together taken as a vector, wherein a number of timing values in the set of timing values corresponds to a number of seismic sources of a seismic acquisition;
apply a predetermined constraint to the vector to determine whether the set of timing values meet or exceed a predetermined threshold; and
generate a finalized time adjustment series comprising the vector when the set of timing values meet or exceed the predetermined threshold.

23. The tangible and non-transitory machine readable medium of claim 22, comprising instructions to apply the predetermined constraint to the vector by determining whether pairs of timing values of the set of timing values have a difference therebetween that meet or exceed the predetermined threshold as a predetermined amount of time.

24. The tangible and non-transitory machine readable medium of claim 22, comprising instructions to select second timing values as a second set of timing values together taken as a second vector;
apply the predetermined constraint to the second vector to determine whether the second set of timing values meet or exceed the predetermined threshold; and
generate the finalized time adjustment series as additionally comprising the second vector when the second set of timing values meet or exceed the predetermined threshold.

25. The tangible and non-transitory machine readable medium of claim 22, comprising instructions to delete the vector when the set of timing values are less than the predetermined threshold.
